(19) United States
(12) Patent Application Publication
(10) Pub. No.: US 2019/0337646 A1
(43) Pub. Date: Nov. 7, 2019

(54) SPACECRAFT

(71) Applicant: AIRBUS DEFENCE AND SPACE SAS, Les Mureaux (FR)

(72) Inventors: Sylvain LECONTE, Toulouse (FR); Bernard DELTOUR, Toulouse (FR); Christophe BEREND, Toulouse (FR)

(21) Appl. No.: 16/303,376

(22) PCT Filed: May 23, 2017
(86) PCT No.: PCT/FR2017/051279

§ 371 Date: Nov. 20, 2018

(30) Foreign Application Priority Data
May 23, 2016 (FR) 16 54593

(51) Int. Cl. B64G 1/58; B64G 1/50; B64G 1/22

(52) U.S. Cl. CPC B64G 1/58; B64G 1/222; B64G 1/503

(57) ABSTRACT

Disclosed is a spacecraft including a body having a face, a radiator carried by the face, and a thermal insulation device capable of thermally insulating the body from the space environment. The thermal insulation device includes a flexible insulating sheet that is movable between an unfolded position in which the flexible sheet covers a coverable area of the radiator, and a position folded on itself in which the coverable area of the radiator is exposed to the space environment. The flexible sheet includes multiple pleats which extend perpendicularly to the direction of movement of the flexible sheet, the pleats being folded against one another when the flexible sheet is in the folded position, the pleats being spaced apart from one another when the flexible sheet is in an unfolded position.

The present invention lies within the field of spacecraft.

In particular, the invention relates to the field of heat control in communications satellites.

Heat dissipation from the payload of communications satellites is achieved by radiators mounted on the north and south walls. These radiators are sized to enable removal of the heat generated by the payload under extreme operating conditions, typically when the payload is operating at full rating, the reflecting surface of the radiators is degraded, and assuming this is during a solstice period and therefore one of the radiators is heated by incident solar radiation.

In the opposite extreme operating conditions, for example when transferring the satellite from its injection orbit to its geostationary orbit, the payload will undergo very cold temperatures. It will then be heated, for example by heaters, to keep it above its minimum operating temperature. The electric power required for this heating can represent up to 30% of the electric power generated by the solar generators. It would be desirable to use this electric power for other purposes, for example to increase the propulsive force of the satellite during the transfer phase and thus shorten the duration of the transfer. This is even more critical when using electric propulsion (alone or in alternation with chemical propulsion), as the transfer time lasts several months.

Patent FR 2,823,182 proposes equipping satellites with deployable radiators having a radiant side and an insulating side. During the satellite's transfer phase to geostationary orbit, the deployable radiators are folded in so that their insulating side is facing towards the space environment. Once in geostationary orbit, the deployable radiators are deployed so that their radiant side is facing towards the space environment.

However, these deployable radiators are expensive, bulky, and complex to install, in particular because of the difficulty of implementing and mounting the systems for transferring heat from the radiators to the deployable radiators.

Furthermore, in the deployed position, the deployable radiators project laterally or vertically from the body of the satellite such that deploying them and folding them cannot be controlled in a manner not tied to the position or movement of the other satellite appendages. The deployed position of the deployable radiator is therefore not compatible with all positions of the solar panels, with all positions of the antennas, or with the use of certain thrusters.

The document “Motorized thermal control shade” by Han Hwangbo describes a thermal insulation device comprising two lateral rolls unrolled by a central rotary shaft. This thermal insulation device is restrictive because it requires piercing the wall of the satellite in order to pass the rotary shaft therethrough. This document also discloses a thermal insulation device comprising a single lateral roll. However, this embodiment requires the heat pipe system supporting the heat dissipating equipment to extend across the entire width of the wall.

The present invention aims to provide a spacecraft having a thermal insulation device that is compact, lightweight, and can be implemented independently of the positions of the other appendages.

To this end, the invention relates to a spacecraft comprising a body having at least one face, at least one radiator (22) carried by said face, and at least one thermal insulation device capable of thermally insulating the body from the space environment; said thermal insulation device comprising at least one flexible insulating sheet that is movable between an unfolded position in which the flexible sheet covers a coverable area of the radiator, and a position folded on itself in which said coverable area of the radiator is exposed to the space environment, characterized in that the flexible sheet comprises multiple pleats which extend perpendicularly to the direction of movement of the flexible sheet, said pleats being folded against one another when the flexible sheet is in the folded position, said pleats being spaced apart from one another when the flexible sheet is in an unfolded position.

According to some particular embodiments, the spacecraft comprises one or more of the following features:
The radiator has longitudinal edges. The flexible sheet is centered with respect to the longitudinal edges of the radiator when the flexible sheet is in the folded position.
The spacecraft comprises solar panels. The coverable area comprises an area of the radiator not covered by the solar panels when the solar panels are in the folded position.
The radiator having an external main face, the thermal insulation device comprises:
   a first flexible sheet and a second flexible sheet each having a fixed edge held stationary relative to the radiator, and an opposite edge referred to as the lateral edge,
   a single drive cable able to drive the lateral edge of the first flexible sheet and the lateral edge of the second flexible sheet simultaneously, said drive cable extending at least two times to the right of the external main face of the radiator in a direction perpendicular to the lateral edges of the flexible sheets, said drive cable being fixed at at least one point of attachment of the lateral edge of the first flexible sheet and at at least one point of attachment of the lateral edge of the second flexible sheet,
   at least four guide rollers suitable for guiding said drive cable, and
   a single motor suitable for driving the drive cable.
Advantageously, this device enables folding and unfolding the two flexible sheets by means of a single drive motor.
The drive cable extends four times to the right of the external main face of the radiator in a direction perpendicular to the lateral edges of the flexible sheets, said drive cable being fixed at two points of attachment of the lateral edge of the first flexible sheet and at at least two points of attachment of the lateral edge of the second flexible sheet, and the thermal insulation device comprises seven guide rollers.
Advantageously, this thermal insulation device is more stable and more robust and allows folding and unfolding the device more quickly with no fear of jamming.
The thermal insulation device comprises a device able to apply tension to the drive cable.
Advantageously, this tensioning device allows absorbing variations in the length of the drive cable due to large temperature variations.
The thermal insulation device further comprises a first drive rod fixed to the lateral edge of the first flexible sheet and a second drive rod fixed to the lateral edge of the second flexible sheet, the one or more drive cable(s) being fixed to the first drive rod and to the second drive rod.
The thermal insulation device further comprises:
   at least one elastic member able to bring the first drive rod and the second drive rod closer together, and
   a release device able to sever the drive cable in the event of the thermal insulation device becoming jammed.
The elastic member and the release device advantageously enable bringing the flexible sheets to a folded position in case of failure of the thermal insulation device.
Advantageously, the drive rods make it possible to drive a thin flexible sheet in a simple manner with no risk of tearing.
The thermal insulation device comprises a cover able to protect the flexible sheet when the flexible sheet is in the folded position.
Said at least one face comprises a north face, a south face, and a zenith (anti-Earth) face, and comprises a thermal insulation panel deployable between a position in which the thermal insulation panel is arranged against the north face or against the south face, and a position in which the thermal insulation panel is arranged against the zenith face.
The thermal insulation panel comprises a rigid structure on which an insulating sheet is fixed.

The invention also relates to a use of a spacecraft having the features mentioned above, during which the thermal insulation device is folded or unfolded, once the spacecraft is in geostationary orbit, according to the thermal variations induced by the seasons or induced by use of the payload.

Advantageously, the thermal insulation device according to the invention is simple and consumes little electric energy.

Advantageously, the thermal insulation device according to the invention is compact. Even in an unfolded position, it does not project beyond the radiator on which it is mounted. It therefore does not create any interference or obstruction for the satellite appendages.

Advantageously, the thermal insulation device of the invention is reversible. It can be unfolded or folded at any moment of the mission.

Advantageously, the thermal insulation device of the invention can cover a selected portion of a radiator. The positioning of this radiator portion can be selected, during manufacture of the satellite for example, according to the payload arranged on the other side of the radiator. The surface area of this portion can be adjusted by folding the flexible sheet to a greater or lesser extent. Advantageously, the thermal insulation device of the invention can be installed later on in the integration phase.

The invention will be better understood from reading the description which follows, given only as an example and with reference to the figures in which:

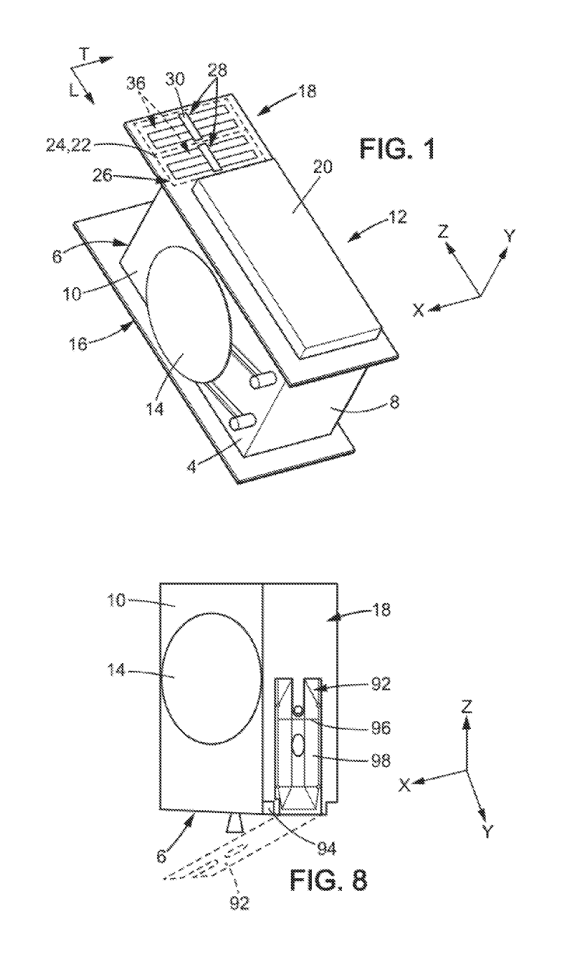

FIG. 1 is a schematic view of a spacecraft according to the invention;

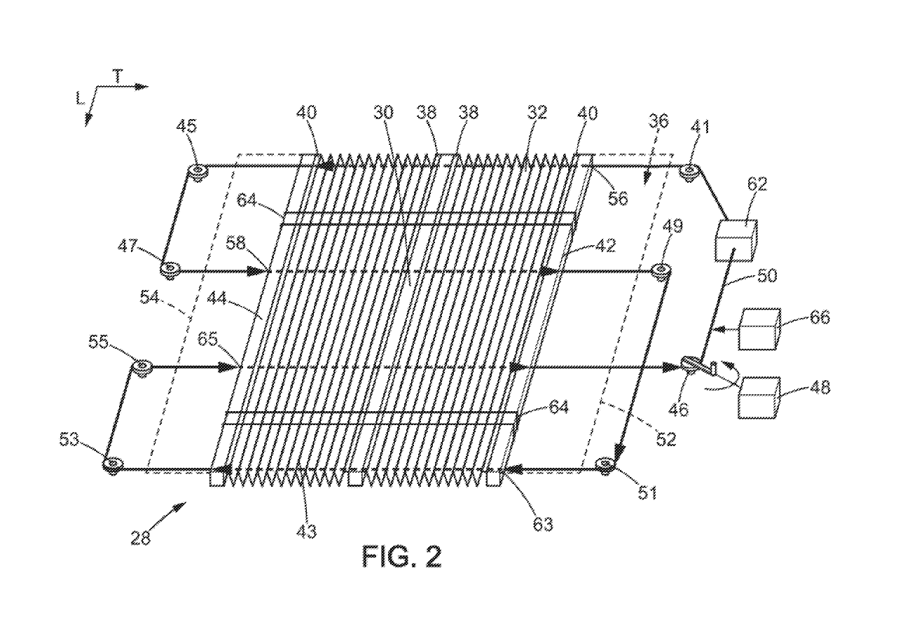

FIG. 2 is a schematic perspective view of a thermal insulation device of the spacecraft according to the invention;

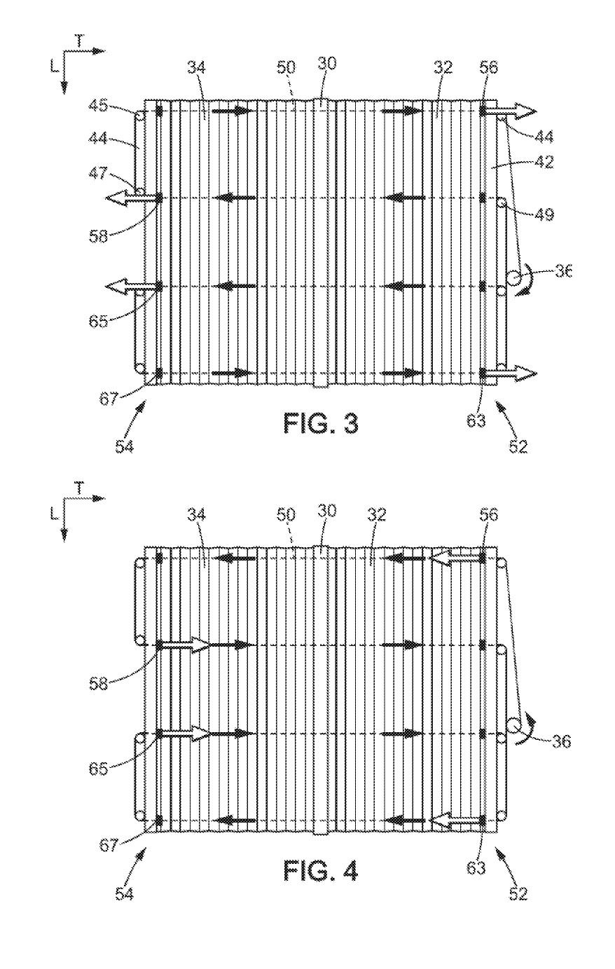

FIG. 3 is a schematic front view of the thermal insulation device shown in FIG. 2, in which the arrows indicate the forces applied to unfold the flexible sheet;

FIG. 4 is a schematic front view of the thermal insulation device shown in FIG. 2, in which the arrows indicate the forces applied to fold the flexible sheet;

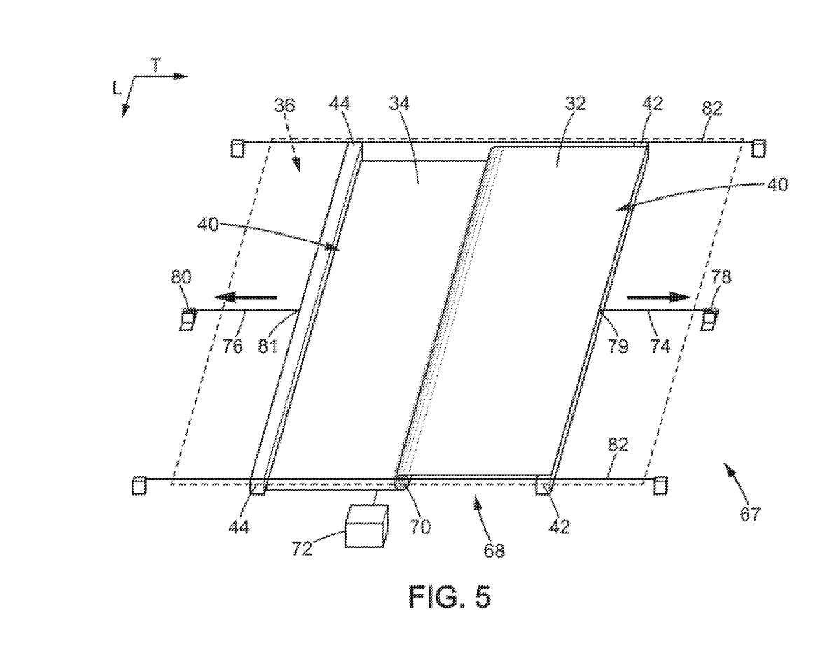

FIG. 5 is a schematic perspective view of a spacecraft according to a first embodiment not covered by the present patent application;

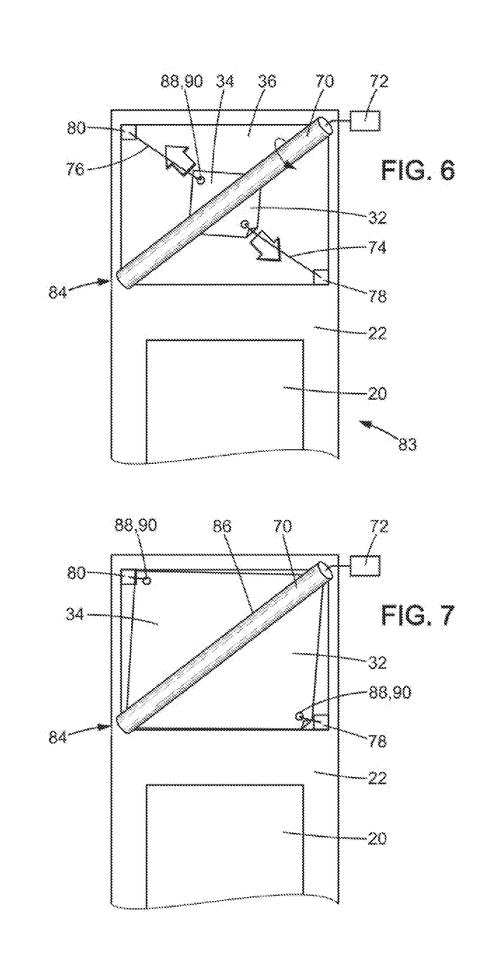

FIG. 6 is a schematic front view of a spacecraft according to a second embodiment not covered by the present patent application and in which the flexible sheet is in a semi-folded position;

FIG. 7 is a view similar to the view of FIG. 6, in which the flexible sheet is in the unfolded position; and

FIG. 8 is a schematic perspective view of a spacecraft having a deployable panel according to the invention.

Referring to FIG. 1, a spacecraft 2 according to the invention is in the form of a parallelepiped body 4. This body 4 always has the same face turned towards the Earth, said face being called the Earth face 6. The opposite side parallel to the Earth face 6 is in turn referred to as the anti-Earth or zenith face 8.

Face +X, also called the east face 10, and face −X, also called the west face 12, are opposite sides that are parallel to each other and perpendicular to the equatorial plane once the satellite is in position in its geostationary orbit. Communication antennas 14 are generally fixed to faces −X 10 and +X 12. Face −Y, also called the north face 16, and face +Y, also known as the south face 18, are two other faces of the body. They are opposite and parallel to one another and perpendicular to the north-south axis of the Earth.

The spacecraft 2 generally comprises a solar panel 20 and a radiator 22 which are fixed on face +Y 18, and a solar panel and a main radiator which are fixed on face −Y 16 (not shown).

The radiators 22 are used for cooling the electronic devices contained in the body. The electronic devices, not shown in the figures, are thermally connected to the radiators, for example by means of heat pipes which are also not shown.

Each radiator 22, of generally parallelepiped shape, has an internal main face fixed on the body and an external main face 24 opposite to the internal main face and on the side facing the space environment external to the spacecraft. The radiator 22 extends in a longitudinal direction L and in a transverse direction T. It has longitudinal edges 26.

The spacecraft 2 further comprises two thermal insulation devices 28 according to a first embodiment of the invention. These two insulation devices 28 are installed on the external face 24 of the radiator, in the extension of one another.

Each thermal insulation device 28 comprises a protective cover 30, and a first flexible insulating sheet 32 and second flexible insulating sheet 34 folded under the protective cover 30 as in the representation of FIG. 1.

The protective cover 30 is, for example, a sheath or a cap.

The first flexible sheet 32 is composed solely of a Kapton sheet. This Kapton sheet may, for example, have an inner face having a thermo-optic coefficient ε=0.05 and an outer face having the following thermo-optic coefficients: α=0.45, ε=0.93.

The inner face of the Kapton sheet is advantageously covered with aluminum. It is arranged facing the radiator 22. The outer face of the Kapton sheet is preferably painted black.

The second flexible sheet 34 is identical to the first flexible sheet.

When the first and second flexible sheets 32, 34 are in the folded position as shown in FIG. 1, they extend in the longitudinal direction L. When the first and second flexible sheets 32, 34 are in the folded position, they are also arranged so as to be centered with respect to the longitudinal edges 26 of the radiator.

According to the invention, the first flexible sheet 32 and the second flexible sheet 34 are movable between an unfolded position in which they cover an area 36 of the radiator, called the coverable area, and a folded position in which they are folded onto themselves so that the coverable area 36 of the radiator is exposed to the space environment.

The coverable area of the radiator 36 is an area not covered by the solar panels 20 when the solar panels 20 are in the folded position. This coverable area 36 of the radiator is provided in the longitudinal extension of the solar panels 20. This coverable area 36 is contained in a space defined by the lateral faces of the radiator 20. In the embodiment shown, this coverable area 36 has a rectangular shape having a first side 52 and a second side 54 oriented along the longitudinal direction L.

Referring to FIG. 2, the first flexible sheet 32 has a substantially rectangular shape having a fixed edge 38 integrally secured to the radiator and fixed with respect thereto and an opposite edge, called the lateral edge 40.

The fixed edge 38 may, for example, be fixed to the protective cover 30.

A first drive rod 42 is fixed all along the lateral edge 40 of the first flexible sheet and a second drive rod 44 is fixed all along the lateral edge 40 of the second flexible sheet.

The first 32 and second 34 flexible sheets comprise a plurality of pleats 43 which extend in the longitudinal direction L. These pleats 43 are folded against one another when the first flexible sheet 32 is in the folded position. These pleats 43 are spaced apart from one another when the first flexible sheet 32 is in an unfolded position. These pleats 43 form an “accordion” configuration.

The thermal insulation device 28 further comprises a mechanism for folding/unfolding the flexible sheets by moving their lateral edge 40 in a direction perpendicular to the direction of these edges. This folding/unfolding mechanism advantageously allows folding the first flexible sheet 32 and the second flexible sheet 34 simultaneously, using only one motor.

This folding/unfolding mechanism comprises seven guide rollers 41, 45, 47, 49, 51, 53, 55, a drive pulley 46, a motor 48 for rotating pulley 46, and a single drive cable 50 able to drive the first drive rod 42 and the second drive rod 44 simultaneously in a movement able to fold or unfold the first flexible sheet 32 and the second flexible sheet 34.

Three guide rollers 41, 49, 51 and the drive pulley 46 are distributed along a first side 52 of the coverable area 36 of the radiator, and four guide rollers 45, 47, 53, 55 are distributed along a second side 54 of the coverable area 36 of the radiator, with the first side 52 and second side 54 oriented along the longitudinal direction L.

The drive pulley 46 has two take-up grooves, one of the grooves having the same function as a guide roller.

Alternatively, the guide rollers are replaced by free pulleys.

In the embodiment shown, the drive cable 50 extends four times to the right of the coverable area 36 of the radiator in a direction corresponding to the direction of movement of the flexible sheets, meaning along the transverse direction T of the radiator.

In particular, the drive cable 50 winds around a first groove of the drive pulley 46. It first extends towards a first guide roller 41 located at one end of the first side 50.

The drive cable 50 then extends in the transverse direction T. It crosses the coverable area 36 of the radiator. It is mounted on a second guide roller 45 located at one end of the second side 52, across from the first roller 44. Within this traversal, the drive cable 50 is fixed to the first drive rod 42 at a point of attachment.

The drive cable 50 then extends in the longitudinal direction L. It is mounted around a guide roller 47 located on the second side 52 of the coverable area 36 of the radiator.

Next, the drive cable 50 extends in the transverse direction T. It crosses the coverable area 36 a second time. It is mounted around a guide roller 49 located on the first side 54 of the coverable area 36. Within this traversal, the drive cable 50 is fixed to the second drive rod 44 at a point of attachment 58. The drive cable 50 then heads in the longitudinal direction L towards a guide roller 51 located at another end of the first side 52 of the coverable area.

Next, the drive cable 50 again follows a similar path. It therefore again stretches above the coverable area 36 between a guide roller 51 and two other guide rollers 53, 55 located on the second side 54 of the coverable area. Each time the drive cable 50 traverses the coverable area 36, it is fixed either at a point of attachment 56, 63 of the first drive rod 42, or at a point of attachment 58, 65 of the second drive rod 44. Next, the drive cable 50 is wound about a second groove of the drive pulley 46.

Advantageously, the points of attachment and the rollers or pulley are distributed substantially equidistant from each other along each side 52, 54 of the coverable area 36.

Preferably, the thermal insulation device 28 comprises a tensioning device 62 for the drive cable. This device is adapted to maintain constant tension in the drive cable 50, despite the temperature variations to which the spacecraft is subjected.

Preferably, the thermal insulation device 28 further comprises at least one elastic member 64 adapted to bring the first drive rod 42 and second drive rod 44 closer together, and a release device 66 able to sever the drive cable 50 in the event of the thermal insulation device becoming jammed.

The elastic member 64 is, for example, composed of an elastic band mounted around the first drive rod 42 and the second drive rod 44.

Preferably, the thermal insulation device 28 comprises an observation device for the drive cable (not shown), able to measure the tension and movement of the drive cable and able to exchange information concerning these observations, for example with the motor 48. This device could, for example, be the tensioning device 62 or could be included in the motor 48. Using the information provided by the motor 48 on the current movements of the drive cable (folding, unfolding, associated speed, etc.), this observation device is able to estimate the opening or closing level of the thermal insulation device 28 (and thus of the coverage of the coverable area 36). The observation device is also able to detect a jamming or cable derailment situation, and to modify the motor actions accordingly. For example, if the drive cable becomes jammed, it may be useful to execute a short movement in the opposite direction (switch from unfolding to folding or vice versa) and then return to the initial operation. In case of a persistent jam of the thermal insulation device 28, the observation device is able to control the release device 66 so that said device severs the drive cable 50.

Alternatively, the thermal insulation device has no protective cover. The flexible sheet is folded directly over a portion of the radiator 20.

Alternatively, the spacecraft comprises a single thermal insulation device of greater length, able to cover the same area 32 of the radiator.

Also alternatively, the spacecraft comprises more than two insulation devices able to cover the same coverable area 36.

Alternatively, the thermal insulation device comprises only one flexible sheet having an edge integrally secured to a longitudinal edge 26 of the radiator. This flexible sheet is able to extend over the same coverable area 36.

Alternatively, the thermal insulation device is able to insulate only a portion of the area located within the extension of the antennas in the folded position.

Alternatively, the thermal insulation device does not comprise first and second drive rods. In this case, the drive cable is directly attached to the lateral edges of the first and second flexible sheets.

Alternatively, the thermal insulation device comprises two drive cables and two independent motors in order to manage the folding/unfolding of the first side 52 and second side 54 independently. Such a variation complicates the system but provides additional resilience in case of motor failure and increased flexibility in managing the covering of the coverable area 36.

Alternatively, the thermal insulation device comprises two motors 48, a main motor and a secondary motor (not shown). The secondary motor is only used as a replacement for the main motor in order to compensation for a malfunction or failure in the main motor. This variant can increase the resilience of the insulation device. It is also possible to duplicate only the most critical part of the motor and not the motor in its entirety. This is a compromise between the generic approach of the solution and the cost of redundancy.

According to a less advantageous alternative, the folding/unfolding mechanism comprises only four guide rollers (or three guide rollers and a pulley). The drive cable 50 only traverses the coverable area 36 twice. The drive cable 50 is attached at a single point of attachment of the first drive rod and at a single point of attachment of the second drive rod.

According to a variant not shown, the thermal insulation device includes first and second flexible sheets 32, 34, in the form of two fans arranged head to tail in the center of the coverable area 36. The flexible sheets 32, 34 comprise pleats, like a fan, each covering a portion of the coverable area 36 in the form of a circular arc when in the unfolded position. The length of the first and second drive rods 42, 44 is at most equal to half the width of the coverable area 36 so that the device does not extend beyond the satellite walls. The thermal insulation device can be unfolded or folded using a single motor to drive both sides of the device, or two motors each driving one side of the device.

According to a less advantageous variant, not shown, the thermal insulation device 28 according to the first embodiment of the invention may be oriented along the transverse direction T, the flexible sheets then moving along the longitudinal direction L of the radiator. However, in general, such a variant requires using a longer, more expensive, and heavier structure than in the case where the flexible sheets move along the transverse direction T of the radiator.

During operation, with reference to FIG. 3, for the unfolding of the first 32 and second 34 flexible sheets, the drive cable 50 is able to exert a force on the first drive rod 42, directed towards the first side 52, at the points of attachment 56 and 63, and a force on the second drive rod 44, directed towards the second side 54, at the points of attachment 58 and 65.

Referring to FIG. 4, for the folding of the first 32 and second flexible sheets 34, the drive cable 50 is able to exert a force on the first drive rod 42, directed towards the center cover 30, at the points of attachment 56 and 63, and a force on the second drive rod 44, directed towards the center cover 30, at the points of attachment 58 and 65.

Referring to FIG. 5, the spacecraft 67 according to a first embodiment not covered by this patent application comprises a thermal insulation device 68 having a roller 70, a motor 72 adapted to rotate the roller 70, and a first flexible sheet 32 and second flexible sheet 34 which are able to be wound around the roller 70.

The roller 70 forms a protective cover for the flexible sheets. It may be arranged on the radiator 22 in the same centered position and in the longitudinal direction L as the thermal insulation device 28 according to the invention.

The first flexible sheet 32 and the second flexible sheet 34 each have a fixed edge (not shown) integrally secured to the roller 70, and an opposite edge referred to as the lateral edge 40.

A first drive rod 42 is fixed along the lateral edge 40 of the first flexible sheet 32 and a second drive rod 44 is fixed along the lateral edge 40 of the second flexible sheet 34.

The first 32 and second flexible sheets 34 are composed in the same manner as the first flexible sheet of the thermal insulation device 28 according to the first embodiment of the invention, except that they do not have pleats 43.

The thermal insulation device 72 comprises a first return spring 74 at constant torque fixed to a point of attachment 79 of the first drive rod 42, a first tension system 78 having a spring of constant torque and fixed to the return spring 74, a second return spring 76 at constant torque fixed to a point of attachment 81 of the second drive rod 44, and a second tension system 80 fixed to the second return spring. The first 78 and second 80 tension systems exert constant tension on the first 74 and second 76 return springs so that they keep the flexible sheets taut during rotation of the drive roller 70. The return force depends on the size of the flexible sheets. This return force is, for example, between 10 and 150 Newtons.

The points of attachment 79, 81 are arranged in the center of the first drive rod 42 and the second drive rod 44.

The return springs 74 and 76 are each arranged at the center of the first side 52 and second side 54 respectively of the coverable area 36 of the radiator.

The return springs 74, 76 do not perform the function of driving the flexible sheets 32, 34. This function is performed by the drive roller 70. The return springs 74, 76 and the tension systems 78, 80 only perform the function of keeping the flexible sheets taut and flat.

Advantageously, guide cables 82 are stretched in the transverse direction T between each end of the roller 70 and the longitudinal ends of the coverable area 36. The first drive rod 42 and the second drive rod 44 are able to slide on the guide cables 82 to facilitate the folding and unfolding of the first flexible sheet 32 and second flexible sheet 34.

Alternatively, the thermal insulation device 68 comprises only one flexible sheet attached to the roller 70. In this case, the flexible sheets in the folded position (meaning the roller 70) are arranged along the transverse direction T, for example along the edge of the radiator 22.

The thermal insulation device 68 of the spacecraft according to this embodiment may also include an elastic member able to bring the first drive rod 42 and the second drive rod 44 closer together in the event of the thermal insulation device becoming jammed.

Alternatively (not shown), the motor 72 may be located externally to the roller. In this case, the motor 72 unfolds the thermal insulation device 68 via drive cables and a spring located inside the roller adapted to return the thermal insulation device to the folded position. Deployment of the thermal insulation device is synchronized by a pulley system on which a single drive cable travels.

Alternatively, the thermal insulation device 68 comprises two independent motors 72, in order to manage the folding/unfolding of the first side 52 and second side 54 independently. Such a variation increases the complexity of the system but provides additional resilience in case of motor failure and increased flexibility in managing the covering of the coverable area 36.

Alternatively, the thermal insulation device 68 comprises two motors 72: a main motor and a secondary motor (not shown). The secondary motor is only used as a replacement for the main motor in order to compensate for a malfunction or failure in the main motor. This variant allows increasing the resilience of the thermal insulation device. It is also possible to provide redundancy only for the most critical part of the motor, and not the motor in its entirety. This is a compromise between the generic approach of the solution and the cost of redundancy.

Alternatively (not shown), the thermal insulation device 68 includes two drive rollers 70 which are parallel and identical, more or less joined, and centrally located in the coverable area 36 of the radiator. Such a variant makes it possible to manage separately the masking of the first side 52 and of the second side 54 of the coverable area 36 of the radiator. This variant corresponds to the device described above for the first embodiment not covered by the present patent application, except that each drive roller 70 will control only one side of the coverable area 36 of the radiator by means of a single flexible sheet 32. Thus, the first drive roller 70 only controls the covering of the first side 52 of the coverable area 36 of the radiator, and the second drive roller 70 controls only the covering of the second side 54 of the coverable area 36 of the radiator. This variant can be used with two motors 72, one motor driving each roller independently. This solution offers additional flexibility and resilience in case of failure of one of the two motors. Alternatively, this embodiment may be used with a single motor 72, this motor driving both rollers at once. This solution simplifies the solution in comparison to a solution with two motors. In both cases, with one or two motors, identically to what was previously described for the second embodiment, this device would include drive rods 42, 44, guide cables 82, and return springs 74, 76.

According to a less advantageous variant (not shown), the thermal insulation device 68 according to this first embodiment not covered by the present patent application may be oriented along the transverse direction T, the flexible sheets then moving along the longitudinal direction L of the radiator. However, in general, such a variant requires using a longer, more expensive, and heavier structure than in the case where the flexible sheets move along the transverse direction T of the radiator.

Referring to FIGS. 6 and 7, the thermal insulation device 84 according to a second embodiment not covered by the present patent application is identical to the thermal insulation device 68 according to the first embodiment not covered by the present patent application, except that the roller 70 extends in an oblique direction relative to the radiator 22, and the first flexible sheet 32 and second flexible sheet 34 have a triangular shape.

The elements of the thermal insulation device 84 according to the second not-covered embodiment which are identical to the elements of the thermal insulation device 68 according to the first not-covered embodiment have the same references and will not be described again.

In this second not-covered embodiment, the first flexible sheet 32 and the second flexible sheet 34 have a side 86 fixed to the roller 70 and an opposite corner 88 provided with a point of attachment 90.

The first return spring 74 is connected to the point of attachment 90 of the corner of the first flexible sheet. The second return spring 76 is connected to the point of attachment 90 of the corner of the second flexible sheet.

Alternatively, similarly to the first not-covered embodiment, the thermal insulation device 84 comprises two independent motors for managing the folding/unfolding of the first flexible sheet 32 and second flexible sheet 34 independently.

Alternatively, similarly to the first not-covered embodiment, the thermal insulation device 84 comprises two motors, a main motor and a secondary motor (not shown). The secondary motor is only used as a replacement for the main motor in order to compensate for a malfunction or failure in the main motor.

Alternatively, similarly to the first not-covered embodiment, the thermal insulation device 84 comprises two drive rollers 70 which are parallel and identical, more or less joined, instead of only one as illustrated in FIGS. 6 and 7.

The thermal insulation device according to the invention can be unfolded during the orbit transfer phase and folded once in geostationary orbit. Then, once in nominal mode, the thermal insulation device according to the invention can be unfolded or folded in order to manage seasonally-induced thermal variations or to compensate for aging of the mirrors. Finally, the thermal insulation device of the invention can be folded in case of a failure in order to reduce the cooling of the payload.

According to an embodiment not shown, the thermal insulation device comprises a sheet of aluminized Kapton onto which is attached at least one spring of constant reaction force (such as coiled metal strips) suitable for exerting a return force on the Kapton sheet and tending to roll it back onto itself. In use, the thermal insulation device is held pressed against the north face 18 or south face 16 by at least one stop which blocks the at least one spring. When one wishes to retract the device, the stops are unlocked, which has the effect of allowing the device to roll into a rolled shape. The rolling/unrolling can occur either gradually and in a controlled manner by means of a motor, or by allowing the springs to uncoil freely. The fixed points of attachment of this retractable device may be located on the bottom of the north and south faces for movement along the longitudinal direction L, or on the lower side of the north and south faces for movement along the transverse direction T.

The insulation device not shown is mainly used during the phase of transferring from the injection orbit to the geostationary orbit, but may also be used once the spacecraft is in position. When the solar generators are folded (at launch), the thermal insulation device is arranged against the north face 18 or south face 16. The thermal insulation device is retracted when not used.

Referring to FIG. 8, the spacecraft 2 further comprises a thermal insulation panel 92 and a motor 94 capable of rotating the thermal insulation panel 92.

The thermal insulation panel 92 is hinged along an axis extending between the north face 18 and the zenith face 6 or between the south face 16 and the zenith face 6. The thermal insulation panel 92 comprises a rigid structure 96 or a rigid frame made of aluminum or carbon fiber reinforced polymer (CFRP) and an insulating sheet 98, for example made of Kapton, covering this structure 96. The thermal insulation panel 92 is deployable between a position in which the thermal insulation panel is arranged against the north face 18 or south face 16, and a position in which the thermal insulation panel 92 is arranged against the zenith face 6.

Similarly to the insulation device not shown, the thermal insulation panel 92 is primarily used during the phase of transferring from the injection orbit to the geostationary orbit, but may also be used once the satellite is in position. When the solar generators are folded (at launch), the thermal insulation panel 92 is arranged against the north face 18 or south face 16. The thermal insulation panel 92 is retracted when not used. This thermal insulation panel 92 is used during the phase of transferring from the injection orbit to the geostationary orbit. Next, the thermal insulation panel 92 is fixed to the zenith face 92.

This thermal insulation panel 92 can be used with all the embodiments of the insulation device described above.

The device of the invention is of particularly advantageous use for protecting satellite radiators from the cold, in a variable manner and without needing to overengineer the internal heating power budget. This is particularly important when one wishes to minimize the power budget required for heating, and therefore to use this power for other functions of the mission. Examples include satellites of limited power or for use during the electric propulsion transfer phase. Another advantage of the invention is to be able to reduce the temperature variations in the satellite. The payload equipment can then be simplified to use equipment that tolerates a smaller temperature range and is less expensive.

The thermal insulation device of the invention allows variable on-demand thermal protection at any time in the mission, regardless of the constraints from the other satellite appendages. This device is therefore compatible with all positions of the solar panels, whether they are folded, partially unfolded, or completely unfolded. In addition, this device does not impose constraints on satellite operations concerning the orientation of the antennas or the use of propulsion. It thus greatly facilitates the task of operators during operations in orbit. The variability of the thermal protection offered allows managing unanticipated situations that may intermittently or continually require more heating power. These include, for example, situations involving a breakdown or under-utilization of the satellite or of a part of the payload.

The thermal insulation device described is simple to implement, making this solution robust, reliable, and inexpensive to develop and install. Furthermore, this device is fast to develop and light to carry onboard. It requires no thermal interconnection with the rest of the satellite, simply an electrical connection for operating the motor. It can therefore be installed on the satellite very late in the schedule.

Finally, the device according to the invention maximizes the protective surface offered while remaining generic. It can thus be used identically on the two north and south walls, regardless of accommodation constraints, which reduces the cost of the complete solution for a satellite.

1. Spacecraft (2) comprising a body (4) having at least one face (6, 16, 18), at least one radiator (22) carried by said face (6, 16, 18), and at least one thermal insulation device (28) capable of thermally insulating the body (4) from the space environment;
said thermal insulation device (28) comprising at least one flexible insulating sheet (32, 34) that is movable between an unfolded position in which the flexible sheet (32, 34) covers a coverable area (36) of the radiator, and a position folded on itself in which said coverable area (36) of the radiator is exposed to the space environment,
wherein the flexible sheet (32, 34) comprises multiple pleats (43) which extend perpendicularly to the direction of movement of the flexible sheet (32, 34), said pleats (43) being folded against one another when the flexible sheet (32, 34) is in the folded position, said pleats (43) being spaced apart from one another when the flexible sheet (32, 34) is in an unfolded position.

2. Spacecraft (2) according to claim 1, wherein the radiator (22) has longitudinal edges (26), and wherein the flexible sheet (32, 34) is centered with respect to the longitudinal edges (26) of the radiator (22) when the flexible sheet (32, 34) is in the folded position.

3. Spacecraft (2) according to claim 1, comprising solar panels (20), and wherein said coverable area (36) comprises an area of the radiator that is not covered by the solar panels (20) when the solar panels (20) are in the folded position.

4. Spacecraft (2) according to claim 1, the radiator (22) having an external main face (24), and wherein the thermal insulation device (28) comprises:
a first flexible sheet (32) and a second flexible sheet (34) each having a fixed edge (38) held stationary relative to the radiator (22), and an opposite edge referred to as the lateral edge (40),
a single drive cable (50) able to drive the lateral edge (40) of the first flexible sheet (32) and the lateral edge (40) of the second flexible sheet (34) simultaneously, said drive cable (50) extending at least two times to the right of the external main face (24) of the radiator in a direction perpendicular to the lateral edges (40) of the flexible sheets, said drive cable (50) being fixed at at least one point of attachment (56, 63) of the lateral edge of the first flexible sheet (32) and at at least one point of attachment (58, 65) of the lateral edge of the second flexible sheet (34),
at least four guide rollers (41, 45, 47, 49, 51, 53, 55) suitable for guiding said drive cable (50), and
a single motor (48) suitable for driving the drive cable (50).

5. Spacecraft (2) according to claim 4, wherein the drive cable (50) extends four times to the right of the external main face (24) of the radiator in a direction perpendicular to the lateral edges (40) of the flexible sheets, said drive cable (50) being fixed at two points of attachment (56, 63) of the lateral edge (40) of the first flexible sheet (32) and at at least two points of attachment (58, 65) of the lateral edge (40) of the second flexible sheet (34), and wherein the thermal insulation device (28) comprises seven guide rollers (41, 45, 47, 49, 51, 53, 55).

6. Spacecraft (2) according to claim 4, wherein the thermal insulation device (28) comprises a device (62) able to apply tension to the drive cable (50).

7. Spacecraft (67,83) according to claim 1, wherein the thermal insulation device (28) further comprises a first drive rod (42) fixed to a lateral edge (40) of the first flexible sheet and a second drive rod (44) fixed to a lateral edge (40) of the second flexible sheet, said one or more drive cable(s) being fixed to the first rod drive (42) and to the second drive rod (44).

8. Spacecraft (2) according to claim 7, wherein the thermal insulation device (28) further comprises:
at least one elastic member (64) able to bring the first drive rod (42) and the second drive rod (44) closer together, and
a release device (66) able to sever the drive cable (50) in the event of the thermal insulation device becoming jammed.

9. Spacecraft (2) according to claim 1, wherein the thermal insulation device (28) comprises a cover (30) able to protect the flexible sheet (32, 34) when the flexible sheet (32, 34) is in the folded position.

10. Spacecraft (2) according to claim 1, wherein said at least one face comprises a north face (18), a south face (16), and an anti-Earth face (6), and comprises a thermal insulation panel (92) deployable between a position in which the thermal insulation panel (92) is arranged against the north face (18) or against the south face (16), and a position in which the thermal insulation panel (92) is arranged against the zenith face (6).

11. Spacecraft (2) according to claim 10, wherein the thermal insulation panel (92) comprises a rigid structure (96) on which an insulating sheet (98) is fixed.

12. (canceled)

13. Spacecraft according to claim 2, comprising solar panels, and wherein said coverable area comprises an area of the radiator that is not covered by the solar panels when the solar panels are in the folded position.

14. Spacecraft according to claim 2, the radiator having an external main face, and wherein the thermal insulation device comprises:
a first flexible sheet and a second flexible sheet each having a fixed edge held stationary relative to the radiator, and an opposite edge referred to as the lateral edge,
a single drive cable able to drive the lateral edge of the first flexible sheet and the lateral edge of the second flexible sheet simultaneously, said drive cable extending at least two times to the right of the external main face of the radiator in a direction perpendicular to the lateral edges of the flexible sheets, said drive cable being fixed at at least one point of attachment of the lateral edge of the first flexible sheet and at at least one point of attachment of the lateral edge of the second flexible sheet,
at least four guide rollers suitable for guiding said drive cable, and
a single motor suitable for driving the drive cable.

15. Spacecraft according to claim 3, the radiator having an external main face, and wherein the thermal insulation device comprises:
a first flexible sheet and a second flexible sheet each having a fixed edge held stationary relative to the radiator, and an opposite edge referred to as the lateral edge,
a single drive cable able to drive the lateral edge of the first flexible sheet and the lateral edge of the second flexible sheet simultaneously, said drive cable extending at least two times to the right of the external main face of the radiator in a direction perpendicular to the lateral edges of the flexible sheets, said drive cable being fixed at at least one point of attachment of the lateral edge of the first flexible sheet and at at least one point of attachment of the lateral edge of the second flexible sheet,
at least four guide rollers suitable for guiding said drive cable, and
a single motor suitable for driving the drive cable.

16. Spacecraft according to claim 5, wherein the thermal insulation device comprises a device able to apply tension to the drive cable.

17. Spacecraft according to claim 2, wherein the thermal insulation device further comprises a first drive rod fixed to a lateral edge of the first flexible sheet and a second drive rod fixed to a lateral edge of the second flexible sheet, said one or more drive cable being fixed to the first rod drive and to the second drive rod.

18. Spacecraft according to claim 3, wherein the thermal insulation device further comprises a first drive rod fixed to a lateral edge of the first flexible sheet and a second drive rod fixed to a lateral edge of the second flexible sheet, said one or more drive cable being fixed to the first rod drive and to the second drive rod.

19. Spacecraft according to claim 4, wherein the thermal insulation device further comprises a first drive rod fixed to a lateral edge of the first flexible sheet and a second drive rod fixed to a lateral edge of the second flexible sheet, said one or more drive cable being fixed to the first rod drive and to the second drive rod.

20. Spacecraft according to claim 5, wherein the thermal insulation device further comprises a first drive rod fixed to a lateral edge of the first flexible sheet and a second drive rod fixed to a lateral edge of the second flexible sheet, said one or more drive cable being fixed to the first rod drive and to the second drive rod.

21. Spacecraft (67,83) according to claim 6, wherein the thermal insulation device (28) further comprises a first drive rod (42) fixed to a lateral edge (40) of the first flexible sheet and a second drive rod (44) fixed to a lateral edge (40) of the second flexible sheet, said one or more drive cable(s) being fixed to the first rod drive (42) and to the second drive rod (44).
